(19) United States
(12) Patent Application Publication
(10) Pub. No.: US 2003/0192762 A1
(43) Pub. Date: Oct. 16, 2003

(54) Active bi-directional overrunning clutch indexing

(76) Inventor: Brent M. Peura, Farmington, MI (US)

Correspondence Address: Mick A. Nylander, GKN Automotive, Inc., 3300 University Drive, Auburn Hills, MI, 48326, US

(21) Appl. No.: 10/423,643

(22) Filed: Apr. 25, 2003

Related U.S. Application Data
(63) Continuation-in-part of application No. 09/754,771, filed on Jan. 4, 2001, now Pat. No. 6,557,677.

(51) Int. Cl. F16D 41/067

(52) U.S. Cl. 192/36; 192/38; 192/20; 192/84.6

(57) ABSTRACT

An active bi-directional overrunning clutch that includes an oil housing. The clutch also includes a flange rotatably supported with respect to the oil housing. An input shaft is connected to the flange. The clutch further includes a plurality of rollers contacting the input shaft and a coupling. A roller cage positions the plurality of rollers with respect to the input shaft and coupling. The friction ground ring is in contact with the roller cage. The clutch also includes a worm gear in contact with the friction member.

This is a continuation-in-part application of Ser. No. 09/754,771, filed Jan. 4, 2001, and entitled “Active Bi-Directional Overrunning Clutch Indexing.”

### BACKGROUND OF THE INVENTION

1. Field of the Invention

The present invention relates to clutches, and more particularly, relates to an active indexing bi-directional overrunning clutch.

2. Description of Related Art

The use of clutches in an all wheel drive vehicle system has been known for years. In a typical all wheel drive system a front axle is a primary drive, while torque to the rear axle is transferred if and when the average speed of the front wheels spin faster than the average speed of the rear wheels. The torque transfer generally occurs if the front wheels have excessive slip and it also can occur during low speed cornering situations. A clutch works as a mechanical disconnect which prevents torque from being transferred from the rear axle to the front axle when not desired. Currently known in the prior art are single direction clutches and bi-directional overrunning clutches and even clutches that use hydraulic systems to effect changes thereon. The bi-directional overrunning clutch differs from the single directional, because it works in both the clockwise and counter clockwise rotational directions. With the bi-directional clutch, if the output of the rear axle is rotating faster in one direction than the input from the front axle there is no torque transmission but if the input speed is equal to the output speed the unit will lock. Also, while in four wheel drive and the reverse gear, the overrunning clutch locking function direction must be changed from the forward direction to the reverse direction. The bi-directional clutch will switch the operation mode dependent on the prop shaft or input speed direction. The use of the bi-directional overrunning clutch provides benefits with regards to braking, stability, handling, and drive line durability.

In a typical ABS braking event disconnecting the front and rear drive line during braking helps to maintain braking stability. During the ABS braking event the locking of the rear wheels must be avoided for stability reasons and hence, the brake systems are designed to lock the front wheels first. During an ABS event any torque transfer from the rear axle to the front axle will disturb the braking system because of potential instabilities on the slippery surfaces. The use of a bi-directional overrunning clutch will decouple the rear drive line once the rear wheels spin faster than the front wheels and will provide excellent braking stability.

The bi-directional clutch will also reduce likelihood of throttle off over steering during cornering of the vehicle. During a throttle off maneuver the clutch will decouple the rear drive line thus forcing all the engine braking torque to the front wheels which will reduce the chance of a lateral slip on the rear axle, which increasing it on the front axle. Therefore, the vehicle tends to under steer on a throttle off condition, a situation which is considered easier to manage by the average vehicle operator.

Bi-directional clutches have provided several advantages to the all wheel drive systems however, a problem can occur during low speed when a vehicle is in a reverse rolling position and then the vehicle operator selects a drive position, after acceleration backlash will occur in the drive line which allows inertia in the engine and other components to build thus transmitting a torque to the rear drive line which induces an engagement phenomenon within the bi-directional clutch mechanism as the vehicle drive line goes from a reverse gear to a forward gear. This phenomenon would often be reported by vehicle owners and is undesirable. Therefore, there is a need in the art for a bi-directional clutch mechanism that has active indexing which will reduce the engagement phenomenon associated with a switch from a forward to reverse gear or reverse to forward gear in an all wheel drive vehicle system.

### SUMMARY OF THE INVENTION

One object of the present invention is to provide an active bi-directional overrunning clutch capable of being indexed.

Another object of the present invention is to provide an active low speed worm gear bi-directional overrunning clutch.

Yet a further object of the present invention is to provide a clutch with active indexing that will reduce the clunk phenomenon of prior art bi-directional clutch mechanisms.

Another object of the present invention is to provide a clutch that will index during rotation reversal before torque is transmitted through a prop shaft of a vehicle.

Yet a further object of the present invention is to reduce the speed difference between the prop shaft and the rear axle pinion shaft which will lock the clutch before any torque reversal or.

Another object of the present invention is to provide a lower cost and easier to install drive train components for a bi-directional overrunning clutch.

Another object of the present invention is to provide an input shaft and inner race that are better capable of sealing the bi-directional clutch from oil leakage.

Still another object of the present invention is to provide an input shaft that is shorter in length, quicker to assemble and reduces the weight of the drive train components.

To achieve the foregoing objects the active bi-directional overrunning clutch includes an oil housing. The clutch also includes a flange rotatably supported with respect to the oil housing. An input shaft is connected to the flange. A plurality of rollers are in contact with the input shaft and a coupling. The clutch also includes a roller cage wherein that roller cage positions the plurality of rollers with respect to the input shaft and the coupling. The clutch further includes a friction ground member in contact with the roller cage and a worm gear in contact with the friction member.

One advantage of the present invention is that active indexing of a bi-directional clutch will occur prior to torque transfer via an electric motor.

A further advantage of the present invention is the reduction of the clunk phenomenon by active indexing of the bi-directional clutch mechanism.

A further advantage of the present invention is the reduction in speed difference between the prop shaft and the rear axle pinion shaft because of the indexing of the clutch, which therefore, locks the clutch before any torque reversal or transmission.

A further advantage of the present invention is a low speed indexing of the clutch from either the reverse to the forward gear or vice versa.

A further advantage of the present invention is to reduce the assembly time and difficulty in assembling for the bi-directional overrunning clutch.

Yet another advantage of the present invention is the reduction in weight by reducing the length of the input shaft.

A further advantage of the present invention is a reduction in run out by decreasing and eliminating tolerance within the pilot and bearing systems.

Other objects, features and advantages of the present invention will become apparent from the subsequent description and appended claims, taken in conjunction with the accompanying drawings.

### BRIEF DESCRIPTION OF THE DRAWINGS

FIG. 1 shows a plan view of a vehicle drive line.

FIG. 2 shows a cross section of the present invention.

FIG. 3 shows a partial cross section taken from the front of the present invention.

FIG. 4 shows a front end view of the present invention according to the present invention.

FIG. 5 shows a cross section of an alternate embodiment according to the present invention.

FIG. 6 shows a cross section of another alternate embodiment according to the present invention.

### DESCRIPTION OF THE PREFERRED EMBODIMENT(S)

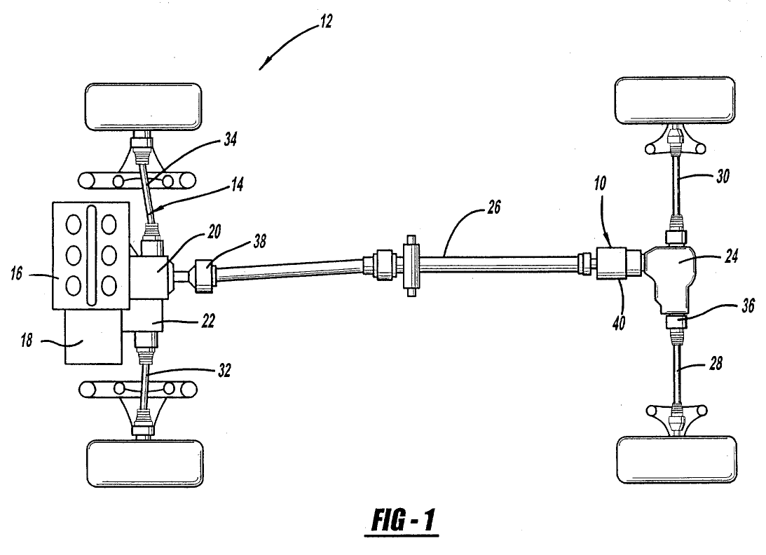

Referring to the drawings, an active bi-directional overrunning clutch 10 according to the present invention is shown. FIG. 1 schematically illustrates an all wheel drive or four wheel drive motor vehicle that is primarily a front wheel driven vehicle, however, the present invention can be used on a primary rear wheel driven vehicle as well.

The motor vehicle 12 as shown in FIG. 1 is primarily driven by a front axle 14. The motor vehicle 12 is an all wheel drive or a four wheel drive vehicle and is driven by power transferred from the engine 16 through a transaxle or gear box 18, which may be an automatic or a manual gear box, into the front differential 22 of the drive train assembly and finally on through to the power takeoff unit 20. In an all wheel drive vehicle power is delivered to the rear differential 24 via a propeller shaft or driving shaft 26 when there is a demand for it. At the rear differential 24 power is split to a left hand rear side shaft 28 and a right hand rear side shaft 30 for distribution to the wheels at the rear of the vehicle. The front differential 22 splits power and slip or spin from the left hand front side shaft 32 and the right hand front side shaft 34. An all wheel drive vehicle distributes power to both the rear differential 24 and the front differential 22 via a distributing drive. In this all wheel drive vehicle configuration either the front axle or the rear axle 36 is the primary driven axle with the other axle only receiving most of the power 14 when needed. The preferred embodiment of the present invention is an all wheel drive vehicle wherein an active bi-directional overrunning clutch 10 is located within or near the rear differential 24 and acts from there to distribute torque to the rear axle 36 of the vehicle during front wheel spin conditions. However, it should be noted that a primary driven rear axle vehicle may also be used with the active bi-directional overrunning clutch 10 installed at or near the front differential 22 of such a vehicle.

The drive train of the vehicle 12 shown in FIG. 1 includes a propeller shaft or drive shaft 26 which transmits power from a power take off unit 38 to the rear differential 24. The rear differential drive 24 includes an axle or oil housing 40 which includes a bi-directional overrunning clutch 10 and a differential housing 42 which is supported about a rotational axis. The differential housing is driven by a vehicle gear box via a driving gear. The bi-directional overrunning clutch 10 will connect to the differential housing 42 via a rear pinion shaft 44 and will only transmit driving torque to the rear axle 36 when the front axle 14 or front wheels are in a spin or slip condition. When the gear has been selected, by the operator, into a forward gear and then is placed into a reverse gear or the opposite, i.e., a reverse gear was selected and then a forward gear selected, the bi-directional overrunning clutch of prior art devices can make an engagement noise which occurs when the rotation of the clutch is changed abruptly from a counter clockwise direction to a clockwise direction or from a clockwise direction to a counter clockwise direction. This engagement phenomenon is noticeable to operators of the vehicle and may be reported as being undesirable.

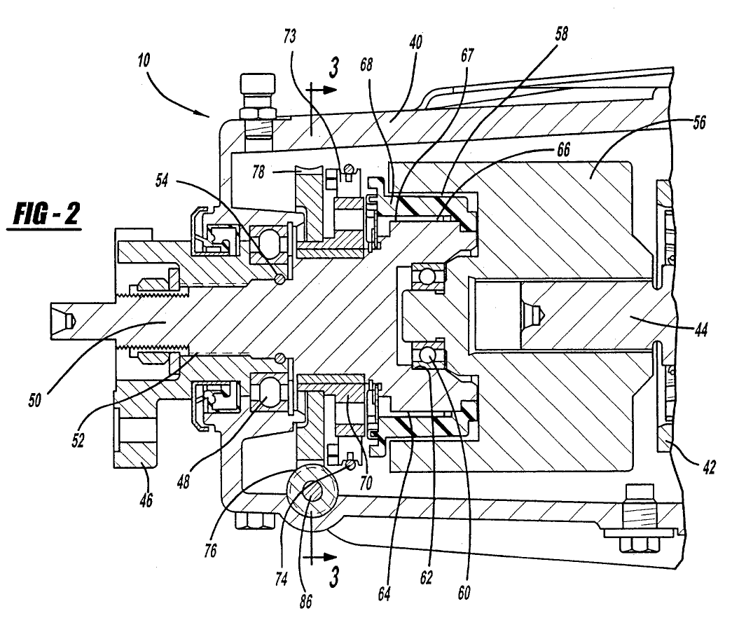

FIG. 2 shows a cross section of the active bi-directional overrunning clutch 10. The clutch 10 is located in an oil housing 40, which is connected to a rear differential 24, (see FIG. 1), and then on to the rear axle 36 and side shafts 28, 30 and finally to the wheels. A flange 46 is connected to the prop shaft 26 which is connected on the opposite end to the front differential 22 and front axle 14. The flange 46 is rotatingly supported within the oil housing 40 by bearings 48. Located within the flange 46 is the input shaft 50 which is connected to the prop shaft 26 via the flange 46. The input shaft 50 is secured within the flange 46 via a network of teeth 52 that interact with the input shaft 50 and the surface of the flange 46. A seal 54 is used as a medium between the input shaft 50 and the flange 46. The input shaft 50 of the bi-directional overrunning clutch 10 rotates at the speed the prop shaft 26 is receiving from the front differential 22 and in whatever direction, i.e., clockwise or counterclockwise, the prop shaft 26 is receiving. At one end of the input shaft 50 is a viscous coupling 56, it should be noted that any other type of coupling may be used but in the preferred embodiment a viscous coupling is the preferred choice. The viscous coupling 56 is integrated with the bi-directional overrunning clutch outer race. The rear axle output is transmitted to and through the rear axle pinion shaft 44. The viscous coupling 56 will smooth the transition between the speed of the input shaft 50 and the speed going to the axle output shaft 44. The viscous coupling 56 contacts a second bearing 60, which also contacts an inner surface 62 of the input shaft 50.

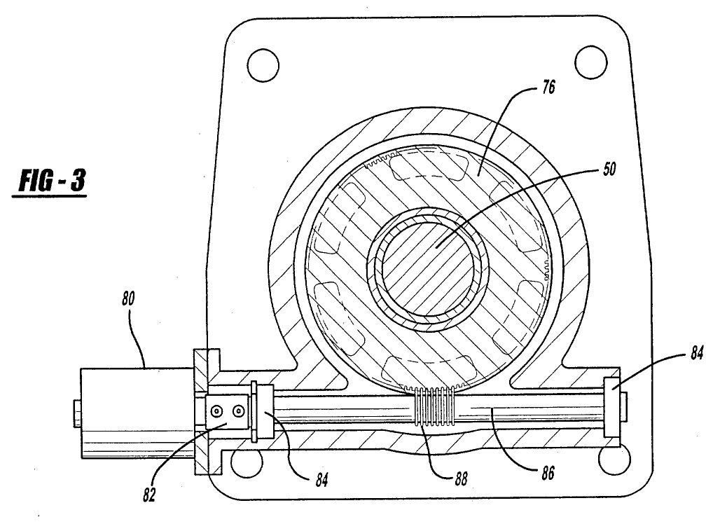

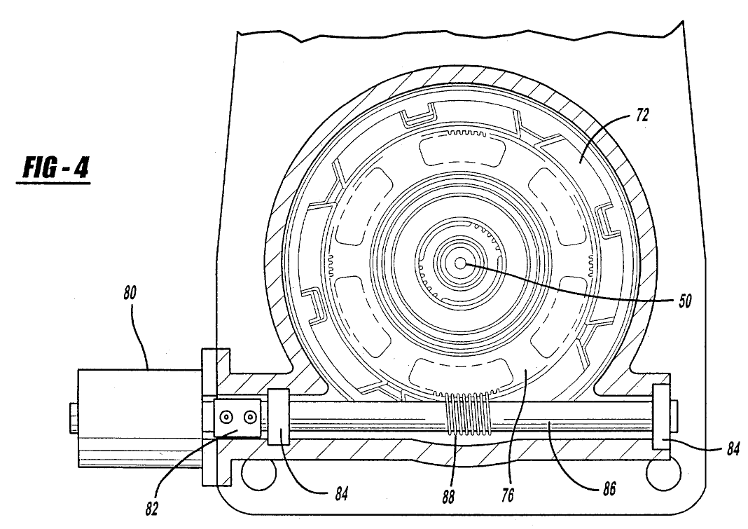

One end of the input shaft 50 includes a plurality of flat surfaces or flats 64. The flat surfaces 64 are on the outer circumference of the input shaft 50. A plurality of rollers 66 are in contact with both the flat surfaces 64 of the input shaft and a surface of the outer race 58. The rollers 66 are held in position on each flat surface 64 by a roller cage 68 which extends in an area between the outer race surface 58 and the input shaft flat surfaces 64. The roller 66 is free to rotate in either direction, i.e., clockwise or counterclockwise with respect to the roller cage 68 thus allowing the roller 66 to position from one end of the flat surface 64 of the input shaft to the other end of a flat surface 64 of the input shaft. This applies to each and every roller 66 on each and every flat surface 64 around the circumference of the input shaft 50. A friction grounding element or ring 70 axially contacts the roller cage 68 at a top surface thereof. The friction grounding element 70 includes a plurality of friction brake shoes 72 as shown in FIGS. 2, 3, and 4. The brake shoes 72 are held into place and provide an element of resistance to the friction ground element 70 via a spring 74. The friction brake shoes 72 are positioned within orifices that are located around an upper circumference of the roller cage 68 and contact the friction grounding element 70, but is not rigidly connected to the friction grounding element 70. The friction grounding element 70 further includes a worm gear 76 that includes a plurality of teeth 78 on an outer circumference thereof. An electric motor 80 is positioned inside or outside the oil housing 40 such that it is mechanically grounded to the oil housing 40. The electric motor 80 is connected via a coupling 82 and bearings 84 to the rod 86 which rotates the gear attached to the friction grounding element 70. The motor 80 is capable of rotating in a clockwise direction or a counter clockwise direction thus rotating the worm gear 76 in either a clockwise direction or a counter clockwise and influencing the rollers 66 with respect to the flat surfaces 64 of the input shaft. The rod 86 of the worm gear 76 includes a plurality of threads 88 such that they engage the teeth 78 of the worm gear 76 and provide the necessary torque to rotate the worm gear 76 in either the clockwise or counter clockwise direction.

The bi-directional overrunning clutch 10 will engage and transmit power to the rear wheels during a slip condition of the front wheels on a primary driven front wheel vehicle and also during tight cornering low speed situations. During normal driving conditions of the all wheel drive vehicle the bi-directional overrunning clutch 10 has the input shaft 50, which is directly connected to the front axle 14 via the prop shaft 26, and the outer viscous coupling race which is connected to the rear axle pinion of the rear axle 36 running at different speeds due to different gear ratios. The outer race 58 which is connected to the rear axle 36 tends to spin faster than the input shaft 50. The bi-directional overrunning clutch 10 at low vehicle speeds tries to drag the friction shoes 72 and keep the roller cage 68 and hence the rollers 66 to the left side or forward gear side of the flat surfaces of the input shaft 50. During this mode, the rollers 66 are spinning in a clockwise direction with and in the same direction as the outer race 58 and rear axle 36 and no torque is being transferred. However, during a front wheel slip condition in the forward vehicle direction the prop shaft 26 and rear axle pinion shaft 44 develops a difference in speed that will decrease to zero when the speeds equal each other and then the input shaft 50 will become the driving member thus compressing the rollers 66 against the outer race 58 of the coupling 56. This will lock the input shaft 50 with the outer race 58 and transmit torque to the housing of the viscous coupling 56 that will in turn transmit the torque to the rear axle pinion 44. The rollers 66 are pinched during this locked condition and will stay locked until a torque reversal, i.e., no front wheel slip occurs.

The roller cage 68 positions the rollers 66 on the input shaft flat surfaces 64 during low and high speed overrun and during initial lock up of the bi-directional overrunning clutch 10. The roller cage 68 is rotating at all times at the input shaft speed. During low speeds the friction brake shoes 72 are pressed against a friction ground with the spring 74. This will create a drag force on the roller cage 68 where that drag force positions the cage 68. This positioning of the cage 68 will in turn position the rollers 66 to one side of the flat surface 64. The direction of this drag force is dependent on the input rotational direction. The rollers 66 are always in constant contact of the outer race 58 during any speed. This contact will tend to spin the rollers 66 as well as create a drag force on the roller 66. During overrun conditions the outer race 58 is rotating faster than the input shaft 50. The direct force on the roller 66 as well as the outer race 58 rotating at a higher angular velocity forces the rollers 66 to traverse from one side of the flats 64 to the other.

During low speeds the brake shoes 72 counteract the drag effect to avoid excessive grounding during any change in direction i.e., reverse to forward or vice versa of the vehicle. The direction change is made by the rotation of the prop shaft 26. The rollers 66 will have to be indexed from the left side to the right side of the flat surfaces 64 of the input shaft by the worm gear unit 76, via the roller cage 68 to the appropriate flat surface side of the input shaft 50 to reduce the clunking effect which occurs if the rollers are not indexed and the rollers are suddenly, via a tremendous amount of torque, forced to the opposite side of the flat surfaces 64.

In operation the active indexing of the bi-directional overrunning clutch 10 will be used to reduce the NVH phenomenon found with traditional bi-directional clutch mechanisms. The NVH effect tends to occur at low speeds after a shift from a forward gear to a reverse gear or the opposite reverse gear to a forward drive gear. The indexing of the bi-directional clutch 10 will occur during rotation reversal before any torque is transmitted through the prop shaft 26 to the viscous coupling 56 and on through to the rear axle 36. The motor 80 is in contact with to the worm drive 76 which is then connected to the friction grounding element 70. In the preferred embodiment the electric motor 80 is connected electronically to the transmission controller of the vehicle operating computer, however, it should be noted that the motor 80 can be connected to any of the onboard computers or sensors in the vehicle depending on weight, size and needs for the motor. The electric motor 80 is controlled by the use of simple computer logic programming. This programming adds a circuit that allows the electric motor 80 to index the rollers 66 from one side of the input shaft flat surfaces 64 to the second side of the input shaft flat surfaces 64 at a predetermined time. The motor 80 will remain on for a predetermined time interval such as approximately two seconds depending on a number of factors such as the speed of the spinning front wheels, etc. When the rollers are indexed or moved before any torque reversal, no backlash will occur in the bi-directional overrunning clutch 10. This will also allow the speed difference across the bi-directional overrunning clutch 10 to be reduced thus lessening the clunk phenomenon.

When the operator of the vehicle selects a drive or a reverse gear after being in a forward gear, the computer logic or replay will first determine which type of gear, reverse and not forward in this case, was selected and then send a signal to the motor 80 to index the roller 66 to the reverse side of the flat surfaces of the input shaft 50. This all occurs during the lag the transmission and engine have because of the front wheel spin in the reverse direction by the vehicle. Therefore, the having the rollers 66 moved to the reverse side of the flat surfaces of the input shaft 50 before any torque transmission is applied to the viscous coupling 56 and then on to the rear axle 36. In the preferred embodiment the motor 80 will be turned on for a period of two minutes and then turned off after the two minute interval has passed on until the opposite direction gear is selected. It should be noted that any other time interval from a few seconds to many more minutes may be used depending on factors and environmental conditions of the drive train system. If a forward gear is selected the logic will then send an electronic signal to the motor 80 and index the rollers 66 to the forward drive side of the flat surfaces of the input shaft 50. The transmission and engine will have a lag when the front wheels incur a spin condition thus delaying the transmission of torque for a predetermined time. Hence, the motor 80 will be left on, assuring indexing of the rollers 66, for a period of two minutes as was the case if the shift lever is placed in the reverse selection. Therefore, even if the vehicle is rolling in a reverse direction and the operator selects a drive or forward gear, then accelerates, the electric motor 80, upon receiving the electronic signal that a forward drive gear was selected, will index the rollers 66 for a period of two minutes thus reducing backlash or NVH phenomenon in the drive line. This occurs even though the inertia of the engine and the transmission have built up, but the rollers 66 will have been indexed before any torque was transmitted. This reduction of the back lash of the rear drive line system will allow for less speed difference between the input prop shaft 26 and the rear axle pinion shaft 94 and will assure that the bi-directional overrunning clutch 10 is locked before any torque transmission occurs. It should be noted that the appropriate worm gear drive or high ratio drive is preferred so that the friction ground ring will not backdrive the motor during standard all-wheel drive operation.

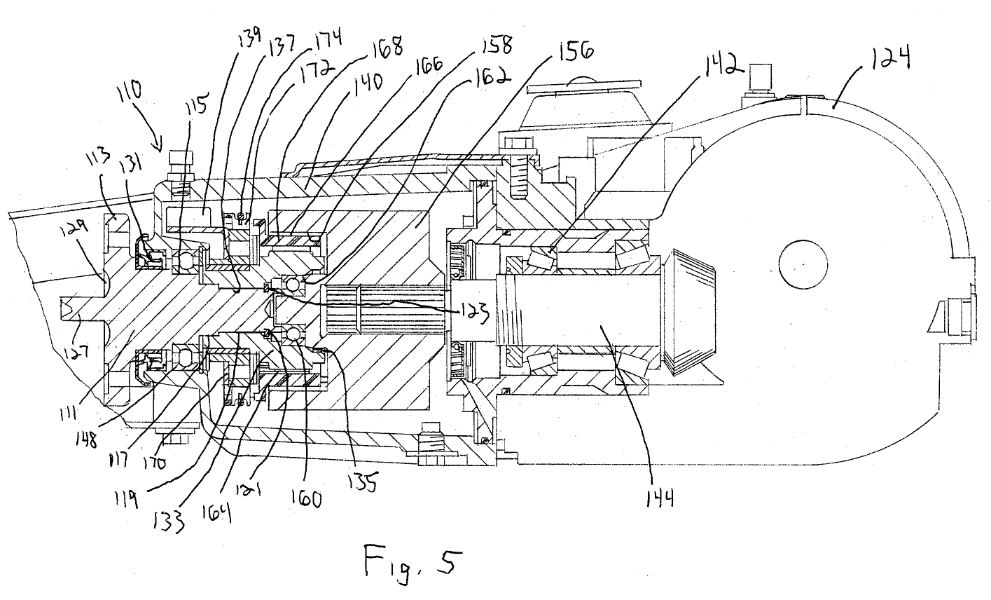

Like numerals indicate like parts. FIG. 5 shows a cross section of an alternative embodiment of a bi-directional overrunning clutch 110. The clutch 110 is located in an oil housing 140, which is connected to a rear differential 124 and then onto the rear axle and side shafts and finally to the wheels. An input shaft 11 is connected to the prop shaft which is connected on the opposite end to the front differential and front axle. The input shaft 111 is rotatingly supported within the oil housing 140 by bearings 148. The input shaft 111 has a flange 113 extending from one end thereof. The input shaft 111 has a pilot surface 115 located on an outer surface of the input shaft 111. The pilot surface 115 is turned or ground, depending on the manufacturing process used for the input shaft 111, with the same set up parameters as a bearing inner race seat 117 which is located adjacent to the pilot surface seat 115. The inner race seat 117 has a reduced diameter in comparison to the pilot seat 115. The arrangement of the two seats directly on the input shaft 111 will allow for the most reduced amount of run out for the bi-directional clutch 110. The input shaft 111 has a plurality of splines or teeth 119 located on one end thereof which in one embodiment are broached onto an end along the longitudinal axis of the input shaft 111. Located on the same end as the splines or teeth 119 is a circumferential channel 121 on an outer surface of the input shaft 111. Arranged within the circumferential channel 121 is a snap ring, tapered snap ring 123 or any other type of fastener known that will be capable of assisting in the securing of the input shaft 111 within the oil housing 140. The flange 113 of the input shaft 111 is integrated with the input shaft 111 such that the input shaft 111 is formed from one solid piece of metal stock. It should be noted that steel is the preferred material but that any other metal, hard plastic ceramic, composite, etc., may be used for the input shaft 111. The flange 113 of the input shaft 111 has a plurality of orifices 125 therethrough that are capable of connecting to a prop shaft via any known flange in the industry such as but not limited to single carden flanges, SGF flanges, CV flanges etc. It should be noted that the input shaft 111 has a cylindrical like protrusion or projection 127 extending from an end of the input shaft 111 having the flange 113. It should also be noted that a circular like depression or trough 129 is located directly along the base of the cylindrical projection or protrusion 127. A seal 131 is located between the oil housing 140 and an outer surface of the input shaft 111 adjacent to or near the flange portion of the input shaft 111. The input shaft 111 of the bi-directional overrunning clutch 110 rotates at the speed the prop shaft is receiving from the front differential and in whatever direction, i.e., clockwise or counterclockwise, the prop shaft is receiving.

A clutch inner race 133 generally having a cylindrical shape is arranged around the end of the input shaft 111 having the plurality of splines 119. The clutch inner race 133 includes an inner bore 135 wherein a plurality of splines or teeth 137 that mate and interact with the plurality of splines and teeth 19 on the outer surface of the input shaft 111 are broached or machined onto the inner surface of the bore 135 of the inner race 133. The inner race 133 is positioned on the end of the input shaft 111 such that the splines 137 on the inner surface of the inner race 133 interact with and mate with the splines 119 on the outer surface of the input shaft 111 such that the inner race 133 is rotatably fixed with respect to the input shaft 111. The clutch inner race 133 and input shaft 111 also have an interference or press fit therebetween that occurs at the bearing inner race seat 117 on the outer surface of the input shaft 111 and on the interior surface of the inner bore on the inner race 133. This press fit will along with the snap ring 123 ensure the inner race 133 and input shaft 111 are fixed relative to each other in an axial direction. The interaction and interengagement of the splines on both the inner race 133 and input shaft 111 will ensure they are rotatably fixed with respect to one another. The snap ring 123 will be arranged within the circumferential channel 121 on the input shaft 111 and will contact a shoulder portion along the inner bore of the inner race 133. It should be noted that the clutch inner race 133 in one embodiment will be made of a steel material but that any other known metal, hard ceramic, composite or hard plastic material may also be used depending on the design requirements of the bi-directional clutch 110.

Arranged near one end or adjacent to the inner race 133 is a coupling 156. In one embodiment the coupling 156 is a viscous coupling, but it should be noted that any other type of coupling may be used for the bi-directional clutch 110. The coupling 156 is integrated with a bi-directional overrunning clutch outer race. The rear axle output is transmitted to and through the rear axle pinion shaft 144. The viscous coupling 156 will smooth the transition between the speed of the input shaft 111 and the speed going to the axle output shaft. The viscous coupling 156 contacts a second bearing 160, which also contacts an inner surface of the clutch inner race 133.

One end of the inner race 133 includes a plurality of flat surfaces or flats 164. The flat surfaces 164 are on the outer circumference of the inner race 133. A plurality of rollers 166 are in contact with both the flat surfaces 164 of the inner race 133 and a surface of the outer race 158. The rollers 166 are held in position on each flat surface 164 by a roller cage 168 which extends in an area between the outer race surface 158 and the inner race flat surfaces 164. The rollers 166 are free to rotate in either direction, i.e., clockwise or counterclockwise with respect to the roller cage 168 thus allowing the roller 166 to position from end of the flat surface 164 of the inner race 133 to the other end of a flat surface 164 of the inner race 133. This applies to each and every roller 168 and each and every flat surface 164 around the circumference of the inner race 133. A friction grounding element or ring 170 axially contacts the roller cage 168 at a top surface thereof. The friction grounding element 170 includes a plurality of friction brake shoes 172. The brake shoes 172 are held in place and provide an element of resistance to the friction ground element 170 via a spring 174. The friction brake shoes 172 are positioned within orifices that are located around an upper circumference of the roller cage 168 and contact the friction grounding element 170, but it is not rigidly connected to the friction grounding element 170. The friction grounding element 170 further includes a grounding spline 139 that is generally located in a pocket of the oil housing 140.

The bi-directional clutch 110 will work in the same manner as described above except it will not have the indexing feature. However, it should be noted that the active indexing feature may be incorporated into the alternate embodiment described in FIG. 5. Any of the active indexing features such as a pin slot mechanism or a worm gear mechanism may be included to actively engage the bi-directional clutch 110 in either a forward or reverse direction. The alternate embodiment shown in FIG. 5 includes a bi-directional clutch 110 using the roller cage 168 and the grounding spline 139 to perform the transfer of torque to a rear axle in an all wheel drive system.

The alternate embodiment of the bi-directional clutch 110 as shown in FIG. 5 provides for a new arrangement of specific components of the bi-directional clutch 110 that will reduce the cost and provide for better system balance performance as well as reducing the amount of leakage from the oil housing 140 of the rear module. The lower cost is achieved by elimination of components from the prior art assembly as well as a decrease in steps for actual assembly of the bi-directional clutch 110. It should be noted that an o-ring seal, a washer, and a nut are eliminated from those needed in a prior art assembly. Furthermore, the removal of these parts decreases the amount of machining operations necessary to create the bi-directional clutch components by transferring some of these operations to the input shaft 111 which will also reduce the costs of creating the components for the bi-directional clutch 110. The better system balance is achieved by eliminating the tolerance stack between the flange pilot and the flange bearing of the prior art systems. The current prior art version has a press fit between the flange which increases the potential variation of run out at the flange pilot. In the embodiment described above for the alternate embodiment in FIG. 5 the flange pilot 115 is turned and ground with the same setup as the bearing inner race seat 117 thus allowing for the most reduced amount of run out given the flange positioning. The current alternate embodiment bi-directional clutch 110 also has reduced leakage because of the elimination of an o-ring seal that was found in the prior art between the flange and the bi-directional clutch input shaft. It could be a problem in the prior art during assembly that the o-ring was periodically missed during assembly leading to an end customer issue of leakage from the oil housing of the rear module. Furthermore, durability and lifetime of the o-ring seal was reduced which could lead to swelling or shrinking of the seal during its lifetime thus reducing the vehicles ability not to leak fluid from its rear differential module. The alternate embodiment shows a bi-directional clutch system 110 that has ease of assembly by utilizing the expansion ring or snap ring 123 that snaps into position automatically when the input shaft 111 and the bi-directional clutch 110 are pressed together in the housing 140. This is much quicker than the prior art method of assembly that involved torquing a nut along with a variety of other steps to be performed. It should be noted that the packaging requirements are also reduced because of the reduced length of the input shaft 111 in the alternate embodiment. This furthermore will also reduce the overall weight of the drive train components thus increasing fuel economy of the motor vehicle.

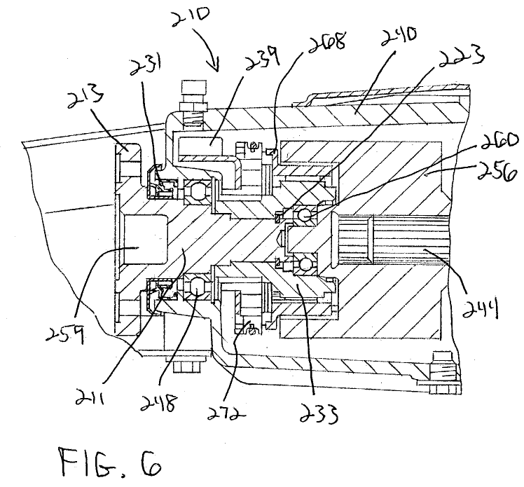

Like numerals indicate like parts. FIG. 6 shows yet another embodiment of the bi-directional clutch 210 according to the present invention. The bi-directional clutch 210 works the same as and has the same parts as those discussed above for FIG. 5. The only difference between the bi-directional clutch 210 of FIG. 6 and FIG. 5 are as follows. The input shaft 211 as shown in FIG. 6 includes a circular shaped cavity 259 located on an end of the input shaft 211 adjacent to the flange portion 213 of the input shaft 211. It should be noted that the cavity 259 maybe other than a circular shape, it may be a triangular shape, hexagonal shape, polygonal shape or any other shape depending on the need and requirements of the prop shaft being connected to the input shaft 211 of the bi-directional clutch 210. The second alternate embodiment as shown in FIG. 6 operates in the same manner as that shown for FIG. 5 and may be capable of having the active indexing systems integrated therein if necessary by design or engineering requirements.

The present invention has been described in an illustrative manner, it is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

What is claimed is:

1. A bi-directional clutch, said clutch including:
a housing;
an input shaft rotatably supported with respect to said housing, said input shaft having a pilot surface;
an inner race arranged around an end of said input shaft;
a coupling adjacent to said inner race;
a plurality of rollers in contact with said inner race and said coupling;
a roller cage arranged between said coupling and said inner race; and
a friction grounding element arranged around said inner race.

2. The clutch of claim 1 wherein said inner race includes a plurality of flat surfaces on one end thereof.

3. The clutch of claim 2 wherein said friction grounding element rotates to index said roller cage and said rollers.

4. The clutch of claim 3 wherein said indexing positions said rollers on a middle position of said flat surface.

5. The clutch of claim 4 wherein said middle position ensures the clutch is in a disconnect mode.

6. The clutch of claim 1 further including a grounding spline connected to said friction grounding element.

7. The clutch of claim 1 wherein said input shaft having a plurality of splines or teeth on one end thereof.

8. The clutch of claim 1 wherein said input shaft having a flange integrated on an end thereof.

9. The clutch of claim 1 wherein said input shaft having a circumferential channel in an outer surface thereof, a snap ring is arranged within said circumferential channel.

10. The clutch of claim 1 wherein said input shaft having a circular cavity on one end thereof.

11. The clutch of claim 1 wherein said input shaft having a cylindrical protrusion extending from an end thereof.

12. The clutch of claim 1 wherein said inner race having a plurality of splines on an inside surface thereof.

13. The clutch of claim 1 wherein said inner race and said input shaft having an interference or press fit therebetween.

14. A rear module for an all wheel drive vehicle, said rear module including:
a rear differential;
an axle pinion contacting a portion of said rear differential;
a coupling rotatably fixed to said axle pinion on an end thereof;
an inner race arranged adjacent to said coupling;
a roller cage arranged between said inner race and said coupling;
a friction grounding element arranged around said inner race; and
an input shaft arranged within said inner race, said input shaft having a pilot surface.

15. The rear module of claim 14 further including a housing connected to said rear differential.

16. The rear module of claim 14 wherein said input shaft having a plurality of splines or teeth on one end thereof.

17. The rear module of claim 14 wherein said input shaft having a flange integrated on one end thereof.

18. The rear module of claim 14 wherein said input shaft having a circumferential channel in another surface thereof, a snap ring is arranged within said circumferential channel.

19. The rear module of claim 14 wherein said input shaft having a circular cavity on one end thereof.

20. The rear module of claim 14 wherein said input shaft having a projection extending from an end thereof.

21. The rear module of claim 14 wherein said inner race having a plurality of splines on an inside surface thereof.

22. The rear module of claim 14 wherein said inner race and said input shaft having an interference or press fit therebetween.

23. A flange and input system for use in a clutch on a vehicle, said flange and input system including:
an input shaft having a pilot bearing surface, said input shaft having a plurality of splines on one end thereof, said input shaft having a circumferential channel near one end thereof, said input shaft having a plurality of orifices on an end opposite of said splines;
an inner race having a bore therethrough, said inner race having a plurality of splines on an inner surface thereof, said inner race arranged around said input shaft; and
a snap ring arranged within said circumferential channel.

24. The system of claim 23 wherein said input shaft having a circular cavity on one end thereof.

25. The system of claim 23 wherein said input shaft having a cylindrical protrusion extending from an end thereof.

26. The system of claim 23 wherein said input shaft and said inner race having an interference fit therebetween.

27. An active bi-directional overrunning clutch, said clutch including:
an oil housing;
a flange rotatably supported with respect to said oil housing;
an input shaft connected to said flange;
a plurality of rollers contacting said input shaft and a coupling;
a roller cage, said roller cage positions said plurality of rollers with respect to said input shaft and said coupling;
a friction ground ring in contact with said roller cage;
a worm gear in contact with said friction ground ring; and
a motor connected to said worm gear.
